(19) United States
(12) Patent Application Publication
(10) Pub. No.: US 2025/0197109 A1
(43) Pub. Date: Jun. 19, 2025

(54) User Propane Tank Moving Apparatus

(71) Applicants: Michael Foley, Winlock, WA (US); Charles Wood, Toledo, WA (US); Martti Lemieux, Echo Bay (CA); Tony Peterson, Woodland, WA (US); Randy Hanson, Onalaska, WA (US); Caleb Vainikka, Waconia, MN (US)

(72) Inventors: Michael Foley, Winlock, WA (US); Charles Wood, Toledo, WA (US); Martti Lemieux, Echo Bay (CA); Tony Peterson, Woodland, WA (US); Randy Hanson, Onalaska, WA (US); Caleb Vainikka, Waconia, MN (US)

(21) Appl. No.: 18/984,744

(22) Filed: Dec. 17, 2024

Related U.S. Application Data
(60) Provisional application No. 63/611,744, filed on Dec. 18, 2023.

(51) Int. Cl. B65G 1/04

(52) U.S. Cl. CPC B65G 1/045; B65G 2201/0235

(57) ABSTRACT

A carousel positioned around a dispensing tank not having a enter hub or physical center axis. Each carousel level has an 11 slot input capacity to receive and store user propane tanks and one open area to allow the robotic picker to pass vertically unobstructed. The carousel rotates clockwise or counterclockwise with the aid of a motorized track mounted next to or under the carousel. Markings along the outer surface of the carousel allow tracking and location. Multiple carousel levels are positioned vertically around the dispensing tank. Carousels ride along castor rails positioned around both inner and outer ridges of carousel. When a stored user propane tank is delivered to a customer, the carousel rotates to an available user propane tank within its available inventory and delivers the user propane tank to a door slide moves user propane tanks to a door users can access.

### BACKGROUND

Today's propane industry suffers from an outdated infrastructure and supply chain that costs the industry extensive amounts both in terms of human capital as well as financial costs. The industry admits it needs to focus on innovation as it suffers from low customer satisfaction. The current supply chain for propane is a status quo, legacy system that has yet to adopt an intelligently connected, data driven automation, within an end-to-end ecosystem. As a result, human error results in accidents, delays in service, and premium insurance costs plaque the industry.

One of the issues the industry faces is the handling and filling of user tanks. Right now tanks have to be filled off sight, or filled by a person coming out of a store or campground or other similar location. Ideally a system would have an automatic filling system and move tanks that are filled through an automatic system to bring tanks to users.

Propane is a strategic energy source for the United States and is heavily used within military, industrial and commercial applications. Throughout the past decade a number of accidents have resulted in both injury and death, increasing insurance rates while at times putting additional strain on the supply of propane.

On the consumer side, we see retail locations challenged with accommodating customers by scheduling employees to cover filling of propane tanks during normal business hours. Untrained employees to fill propane means customers wait or are forced to purchase from other locations. And even when employees are trained, lack of proper visual assessment of tanks and improper filling have led to deadly accidents.

The main problems of the current system are:

No automated filling capability or user propane tank purchasing at user interface locations or point of purchase, a person is required to fill the tanks, and that person has many other duties. The other option is to send empty tanks back to a central filling location which increases cost.

There is not an easy purchasing process for users, the propane tanks are in a secure area of a current distribution site, the user must enter a store or other facility, purchase a filled tank, either leaving their tank behind or arranging to find someone to fill their tank. The purchase process of the current system can sometimes take 15 plus minutes and is very inconvenient.

One of the key issues in all of the points is that tanks come and have to be filled by a person. A much better system is to have tanks filled automatically and then stored for when a person is ready to purchase.

A storage and distribution system is needed to do that. The device disclosed is a carousel system with one to four levels coordinated with an automatic picker to move user tanks from an entry point, to a filling location to a distribution point. The carousel is designed to be used with an automatic tank filling nozzle.

### SUMMARY OF THE INVENTION

The carousel is positioned around a distribution tank, the carousel not having a center hub or physical center axis. There is a gap between outer edge of carousel and outer diameter of distribution tank to allow free movement of carousel. An open section in each carousel level allows robotic picker to pass vertically unobstructed past carousel.

Each level of the carousel has a series of fixtures that extend above the carousel level and below the level of the carousel level, each fixture above and below the carousel level with castors to allow free movement of the carousel. A motor located at each carousel level engages with the carousel to rotate the carousel when propane tanks are purchases and need filling. engages with each

Gears along outer edge of carousel interact with direct drive motor to rotate carousel. An inner lower ridge provides contact area for rail castors. Rail castors are mounted to carousel fixture arm to position the carousel. Each propane slot within carousel has a contoured recessed area to accept both 20 lbs and 30 lbs propane tanks. Propane tanks are stored upright with the base of the tank nesting in the propane slot. The propane slot is contoured around the base of the propane tank to minimizes movement and provide stability. Each propane slot has an open bottom allowing propane tanks to enter and exit propane slot without creating any vacuum. Each propane slot is identified and linked and tracked to the inventory tracking software of a propane tank distribution system. Each propane tank is empty and only filled after a purchase is completed.

An alternative to the door slide is a propane tank storage system with a rotating arm system that rotates the propane tank from the user input location to the unit's storage system prior to filling. The rotating arm system may also be used to move filled tanks from the storage location to the dispensing point.

### BRIEF DESCRIPTION OF DRAWINGS

FIG. 1 shows the outer frame that supports the carousel device.

FIG. 2 shows the carousel levels and the open pass-through slot of the propane fill station. Each carousel has eleven open slots.

FIG. 3 shows a top view of carousel and the eleven open slots as well as the open pass-through slot.

FIG. 4 shows the drawer slide as it travels along a horizontal axis.

FIG. 5 shows propane tank base fully docked into tank recess docking area of the carousel.

FIG. 6 shows the robotic picker retrieving new 20 lbs and 30 lbs tanks from the carousel, and three vertical arms compressing around the body of the propane tanks.

FIG. 7 shows the empty carousels aligned in a vertical orientation.

FIG. 8 shows the carousel levels fully stocked with propane tanks.

FIG. 9A distribution tank positioned in a vertical orientation with a regulator on top with a propane fill line extending horizontally to the fill valve past the outer diameter of the distribution tank, with the distribution tank surrounded by the carousel device.

FIG. 10 shows how a series of upper and lower fixtures with castors allow free movement of carousel.

FIG. 11 shows an embodiment to replace the door slide the propane tank storage system with a rotating arm system that rotates the propane tank from the user input location to the unit's storage location, prior to filling.

FIG. 12 shows another embodiment with horizontal storage of the user propane tank.

### DESCRIPTION OF NUMBERS IN DRAWINGS

1. Main enclosure, shown with dotted lines.
2. Distribution tank.
3. User tank.
4. Carousel
9. Drawer Slide
11. Carousel levels.
16. Outer frame.
18. Carousel rotation rails.
19. Cross arms connected to outer frame.
20. Open pass through slot in carousel levels.
21. Open slots for placing user tanks
22. First position when user tank placed in door slide
23. Second position when user tank moves into carousel on the door slide.
24. User tank propane tank base.
25. User tank recess docking area.
36. Robot picker.
37. Vertical arms on robot picker.
38. Arrows show vertical path of the robot picker.
39. Lower position of the robot picker.
40. Carousel device without user tanks.
41. Carousel device fully loaded with user tanks.
42. Distribution tank top flange connecting fill lines, regulator and valves.
43. Propane fill line extends out of distribution tank vertically and shortly after has 90 degree turn.
44. Propane fill line extends outwards beyond diameter of distribution tank horizontally.
45. Propane fill line turns downward with 90 degree connection.
46. Fill valve extending outwards beyond diameter of the distribution tank.
47. Distribution tank vertical metal supports.
48. Distribution tank grounding location.
49. Distribution tank pedestal open area to allow motorized drawer to partially slide under the distribution tank.
50. Gap between outer edge of carousel and outer diameter of dispensing tank.
51. Opening so the robot picker can move up and down.
52. Upper fixture on carousel level with castors.
53. Lower fixture on carousel level with castors.
55. Gears holes along outer edge of carousel that interact with direct drive motor(s) to rotate carousel.
56. Inner lower ridge that provides contact area for rail castors.
70. User tank holder when pivoting device replaces door slide.
71. Pivoting device around pole when pivoting device replaces door slide.
73. User tank stored horizontally
74. Horizontal robot picker

### DETAILED DESCRIPTION

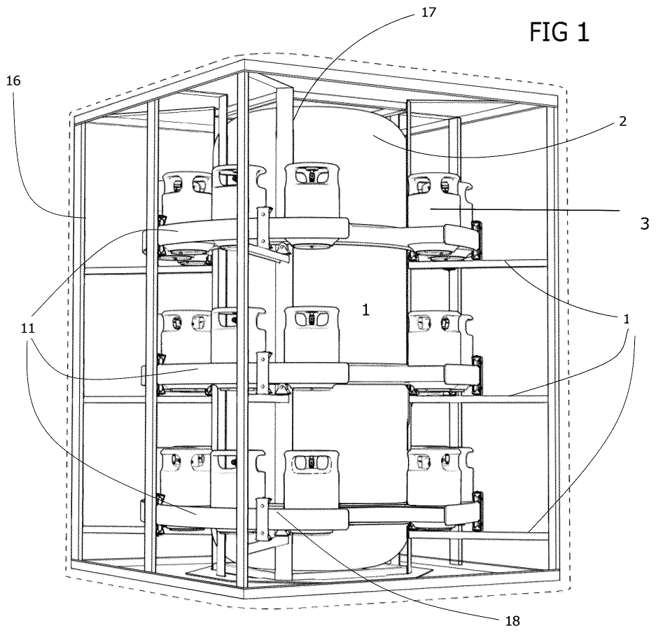

FIG. 1 shows the outer frame 16 of the carousel device. The main enclosure 1 is attached to the outer frame. Cross arms 19 connect outer frame and inner frame 17, with the Carousel Rotation Rails 18 being fixed to the cross arms an allow the carousel 11 to rotate easily with very little friction. The Distribution Tank 2 is fixed into positioned within center of internal frame. User tanks 3 are positioned in the carousel.

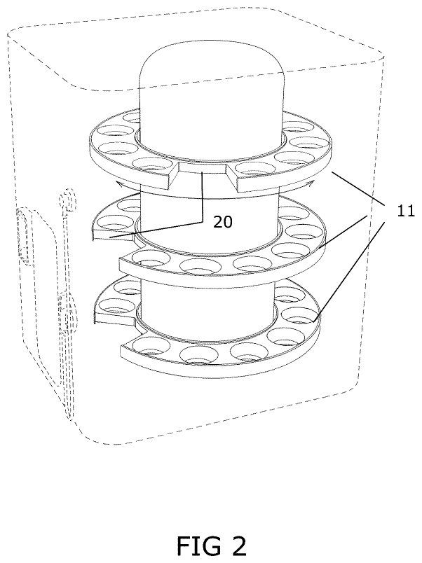

FIG. 2 shows the carousel levels 11 and the open pass-through slots 20 in the carousel levels 11. Each carousel has Eleven Open Slots 21 to receive either a 20 lbs or 30 lbs propane tank. Carousels rotate left and right, there is no physical hub or center axis.

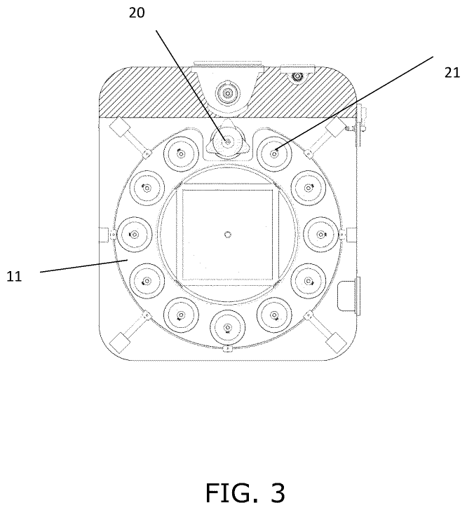

FIG. 3 shows a top view of carousel 11 and the Eleven Open Slots 21 as well as the open pass-through slot 20.

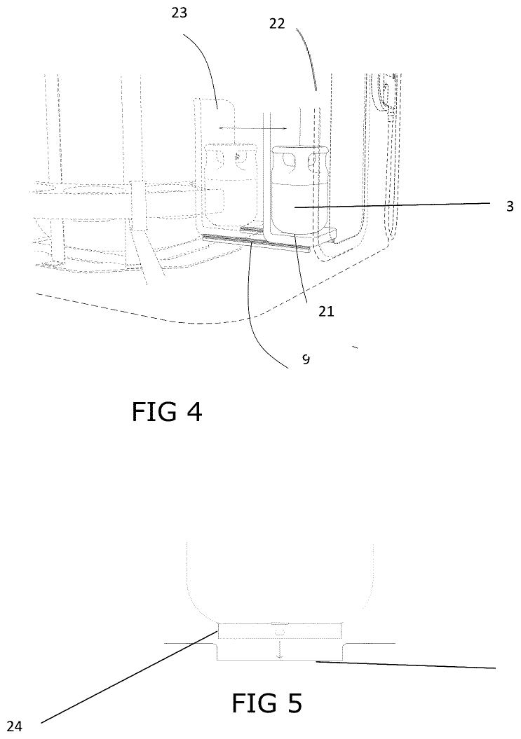

FIG. 4 shows the drawer slide 9, travels along a horizontal axis moving from position 22 to position 23, moving propane tanks into the open pass-through slot of the carousel. Each carousel level has Eleven Open Slots 21 to receive either a 20 lbs or 30 lbs propane tank. Carousels rotate left and right, there is no physical hub or center axis.

FIG. 5 shows propane tank base 24 fully docked into Tank Recess Docking Area 25.

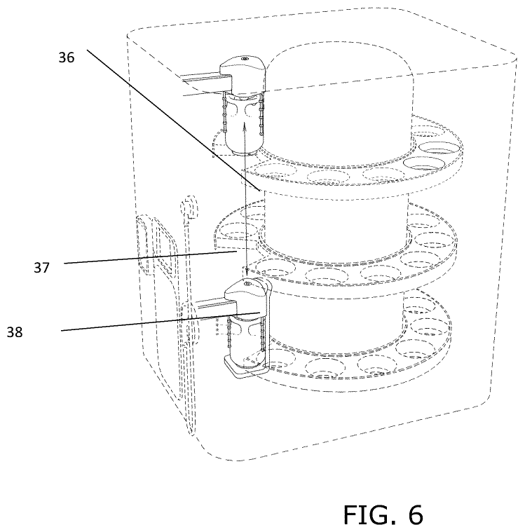

FIG. 6 The Robotic Picker retrieves new 20 lbs and 30 lbs tanks from the carousel, three or four carousel levels. 37 compress around the body of the propane tanks. The Robotic Picker loads tanks onto the drawer slider for propane filling. Robotic picker travels along a single vertical plane 38.

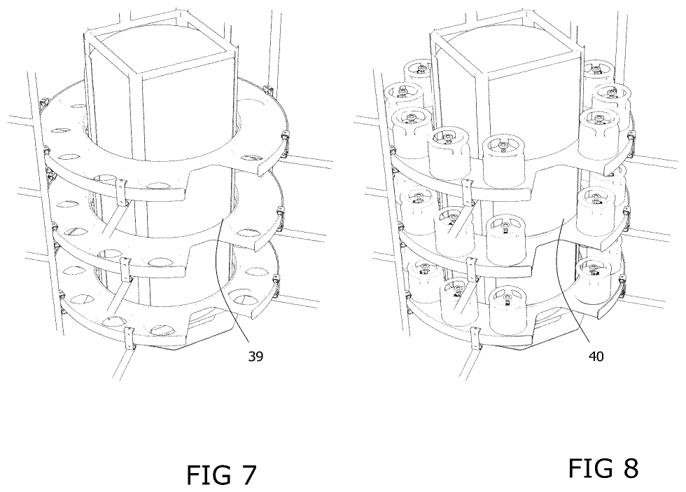

FIG. 7 shows the empty carousels aligned in a vertical orientation 39 with an 11-tank capacity for each carousel level and a total of up to forty-four propane tank carousel 4 storage capacity.

FIG. 8 shows carousels fully stocked 40 with propane tanks.

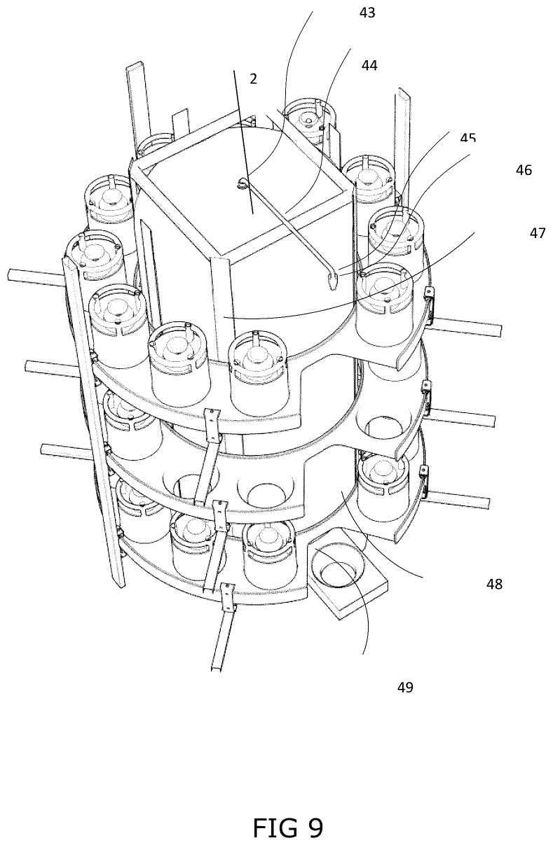

FIG. 9 shows the distribution tank top flange connecting attachments fill lines, regulators and valves 43. The propane fill line 44 extends out of distribution tank vertically and shortly after has 90 degree turn 45. At the end of the fill line's 90 degree is the fuel nozzle 46

The distribution tank 2 is enclosed 47 by vertical metal supports to position and orient the distribution tank within enclosure. Distribution tank is grounded at point 48 to avoid electrical discharge. The distribution tank pedestal 49 has open area to allow a motorized drawer to partially slide under the distribution tank, the motorized drawer holding motors to drive components within the carousel device.

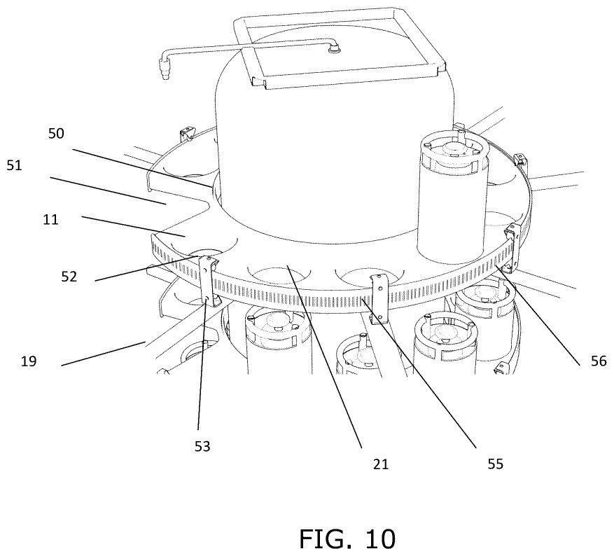

FIG. 10 carousel level 11 positioned around the distribution tank not having a center hub or physical center axis. A gap 50 between inner edge of the carousel levels and the outer diameter of the distribution tank allows free movement of the carousel levels. Open section in carousel 51 allows the robotic picker to pass vertically unobstructed past carousel.

Carousel is positioned within a series of upper fixtures with castors 52 and lower fixture with castors 53 to allow free movement of carousel. Gears 54 along outer edge of carousel interact with direct drive motor (which is stored motorized drawer that fits under the distribution tank) to rotate carousel. Inner lower ridge 55 provides contact area for rail castors. Each propane slot within carousel 21 has a contoured recessed area to accept both 20 lbs and 30 lbs propane tanks. Propane tanks are stored upright with the base of the tank nesting in the propane slot. The propane slot is contoured around the base of the propane tank to minimizes movement and provide stability. Each propane slot has an open bottom allowing propane tanks to enter and exit propane slot without creating any vacuum. Each propane slot is identified and linked and tracked to the inventory tracking software. The support arms 19 connecting the carousel levels to the outer frame are also shown.

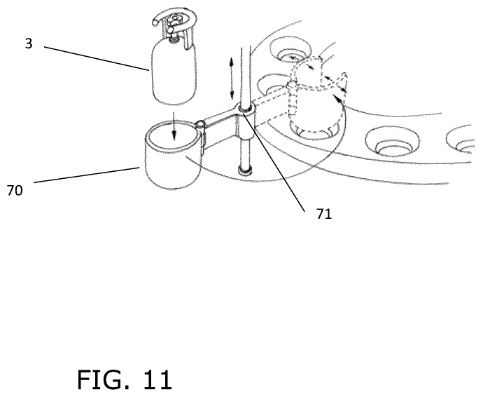

FIG. 11 is an alternative to the door slide a rotating arm system that rotates the propane tank from the user input location to the units storage location, prior to filling. The rotating arm system may also be used to move filled tanks from the storage location to the dispensing point.

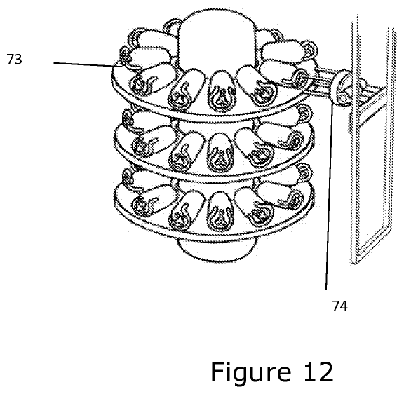

FIG. 12 shows an alternative method of storing the tanks, horizontal versus vertical.

I claim:

1. A user propane tank moving apparatus that positions user propane tanks for filling and return filled user propane tanks to users comprising:
a carousel with one or more levels positioned around a distribution tank;
each carousel level with slots for holding 20 or 30 pound user propane tanks;
a gap between an inner edge of the carousel and an outer diameter of distribution tank to allow free movement of carousel levels;
a robot picker that moves in a vertical plane;
an open section in each carousel level allows the robotic picker to pass vertically unobstructed past carousel levels;
a door slide that moves user tanks into and out of the propane moving apparatus;
a drive motor(s) to turn gears that along the outer edge of carousel levels;
upper fixtures with castors and lower fixtures with castors placed at periodic locations on each carousel level.

2. The user propane tank moving apparatus of claim 1 which stores tanks horizontally.

3. The user propane tank moving apparatus of claim 1 with a rotating tank placement system replaces the door slide.
